(19) United States
(12) Patent Application Publication
(10) Pub. No.: US 2025/0033510 A1
(43) Pub. Date: Jan. 30, 2025

(54) CHARGING CONTROL SYSTEM FOR A VEHICLE

(71) Applicant: GM Global Technology Operations LLC, Detroit, MI (US)

(72) Inventors: Matthew Edward Gilbert-Eyres, Rochester Hills, MI (US); Matt Neely, Rochester, MI (US); Eric T. Hosey, Rochester Hills, MI (US); Russell A. Patenaude, Macomb Township, MI (US)

(73) Assignee: GM Global Technology Operations LLC, Detroit, MI (US)

(21) Appl. No.: 18/360,235

(22) Filed: Jul. 27, 2023

(51) Int. Cl. B60L 53/66; B60L 53/65; B60L 53/68; B60L 58/13; B60L 58/22

(52) U.S. Cl. CPC B60L 53/66; B60L 53/65; B60L 53/68; B60L 58/13; B60L 58/22; B60L 2240/72; B60L 2240/80; B60L 2250/16; B60L 2260/52

(57) ABSTRACT

A charging control system for a vehicle includes a user device that includes a display and data processing hardware in communication with the display and executing a charging application that stores a charging profile, a vehicle profile, and saved charging options. The charging control system also includes a vehicle controller communicatively coupled to the user device via a network. The vehicle controller stores at least one of battery power, battery life, and battery capacity of a vehicle battery and is configured to update the vehicle profile of the charging application and provide charge options on the display. The charge options include at least one of a charge time, charging locations, and battery capacity when the charging application is executed on the data processing hardware.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to a charging control system for a vehicle.

Vehicles utilize communication systems to transmit data and power to various devices. Many conventional vehicles are equipped with ports or outlets configured to provide power to devices while some vehicles utilize wireless charging through magnetic sensors. In some conventional vehicle systems, a user device may be plugged into the vehicle and display various user interface applications on the display of the vehicle. These user interface applications may include navigation, music, and messaging. Other conventional vehicles are separately equipped with navigation systems and may also include temperature sensors to detect an ambient temperature in an around the vehicle.

While conventional vehicles may include a variety of applications for use in operation of the vehicle or in combination with various internal and external devices, conventional vehicles do not typically provide real-time monitoring of a vehicle battery during use of each application. Further, if a battery of the vehicle remains in use and/or is connected to a device after use of the vehicle, a conventional vehicle may alert the occupant via an audio signal or may automatically turn-off the vehicle battery without taking further action.

### SUMMARY

In one configuration, a charging control system for a vehicle includes a user device that includes a display and data processing hardware in communication with the display and executing a charging application that stores a charging profile, a vehicle profile, and saved charging options. The charging control system also includes a vehicle controller communicatively coupled to the user device via a network. The vehicle controller stores at least one of battery power, battery life, and battery capacity of a vehicle battery and is configured to update the vehicle profile of the charging application and provide charge options on the display. The charge options include at least one of a charge time, charging locations, and battery capacity when the charging application is executed on the data processing hardware.

In some aspects, the data processing hardware may be configured to execute a charge protocol for an external device in response to a user input selecting one of the saved charging options. The user input may include a charge time and the vehicle controller may be configured to provide the battery power of the vehicle battery in response to the user input and to provide the battery capacity in response to the charge time. The data processing hardware may be configured to provide a notification on the display that indicates the battery life is at a minimum battery life and is configured to display nearby charging stations for the vehicle. In some examples, the charging profile may store a charge time, and the vehicle controller may be configured to communicate with the data processing hardware the battery capacity via the network based on the charge time.

The battery capacity may indicate a minimum battery range, and the vehicle controller may be configured to stop the charge time at the minimum battery range. In other examples, the data processing hardware may store a weather application in communication with the charging application, and the data processing hardware may be configured to issue notifications to a user in response to data received from the weather application. The data processing hardware may be configured to charge a utility external device in response to a weather notification from the weather application.

In another configuration, a charging control system includes a user device that includes a display and data processing hardware in communication with the display. The data processing hardware stores a weather application and a charging application that, when executed on the data processing hardware, cause the data processing hardware to perform operations in response to a user input corresponding to a charge protocol and weather data received from the weather application. The charging control system also includes a vehicle controller that stores a battery capacity of a vehicle battery and is configured to receive a signal from the data processing hardware and provide the battery capacity to the data processing hardware. The data processing hardware is configured to determine a charging threshold of a vehicle battery based on the battery capacity and adjust a charge time of the charge protocol in response to the weather data received and the charging threshold of the vehicle battery.

In some examples, the battery capacity may include a first battery capacity of a first vehicle battery and a second battery capacity of a second vehicle battery. The first battery capacity may be selectively coupled to the second battery capacity. The user device may store a navigation application, and the data processing hardware may be configured to calculate a route battery threshold based on the battery capacity, the charge protocol, a start location, and an end location. The data processing hardware may be configured to determine whether the end location exceeds the route battery threshold. In some examples, the vehicle controller may be configured to prompt the data processing hardware with battery rationing options at a minimum battery range based on the battery capacity. In some aspects, a vehicle includes the charging control system.

In a further configuration, a charging control system for a vehicle includes a user device including a display and data processing hardware in communication with the display. The data processing hardware stores a weather application and a charging application that when executed on the data processing hardware cause the data processing hardware to perform operations in response to receiving a user input corresponding to a charge protocol and receiving weather data from the weather application. The charging control system also includes a vehicle controller that stores a first battery capacity of a first vehicle battery and a second battery capacity of a second vehicle battery. The vehicle controller is configured to receive a signal from the data processing hardware and provide the first battery capacity and the second battery capacity to the data processing hardware. The data processing hardware is configured to adjust a charge time of the charge protocol based on one of the first battery capacity and the second battery capacity.

In some aspects, the vehicle controller may be configured to selectively draw from the second battery capacity to supplement the first battery capacity. The user input may include selecting a combination protocol stored by the charging application. The charging application may be configured to simultaneously utilize the first battery capacity and the second battery capacity to execute the combination protocol. In some examples, the data processing hardware may be configured to prompt a user with an option to adjust the charge protocol based on the weather data received from the weather application. Optionally, the charging application may be configured to display a power consumption of at least one of the first battery capacity and the second battery capacity by at least one external device. The vehicle controller may be configured to redirect power from unused power sources to maximize at least one of the first battery capacity and the second battery capacity.

### BRIEF DESCRIPTION OF THE DRAWINGS

The drawings described herein are for illustrative purposes only of selected configurations and are not intended to limit the scope of the present disclosure.

FIG. 1 is a perspective schematic view of a vehicle according to the present disclosure in communication with a user device;

FIG. 2 is a schematic view of a user device with a charging application according to the present disclosure;

FIG. 3 is a schematic view of a charging application displayed on a user device according to the present disclosure;

FIG. 4 is a schematic view of a user device receiving a weather notification on a charging application of the present disclosure;

FIG. 5 is a schematic view of a user device with a navigation application according to the present disclosure;

FIG. 6 is a schematic view of a user device with a notification of a charging profile according to the present disclosure;

FIG. 7 is a schematic view of a charging application of the present disclosure in communication with a first vehicle controller and a second vehicle controller;

FIG. 8 is a schematic view of a first vehicle and a second vehicle according to the present disclosure electrically coupled with a house;

FIG. 9 is an example flow diagram of a charging control system according to the present disclosure;

FIG. 10 is an example flow diagram for the charging control system of FIG. 9; and

FIG. 11 is an example flow diagram for the charging control system of FIGS. 9 and 10.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

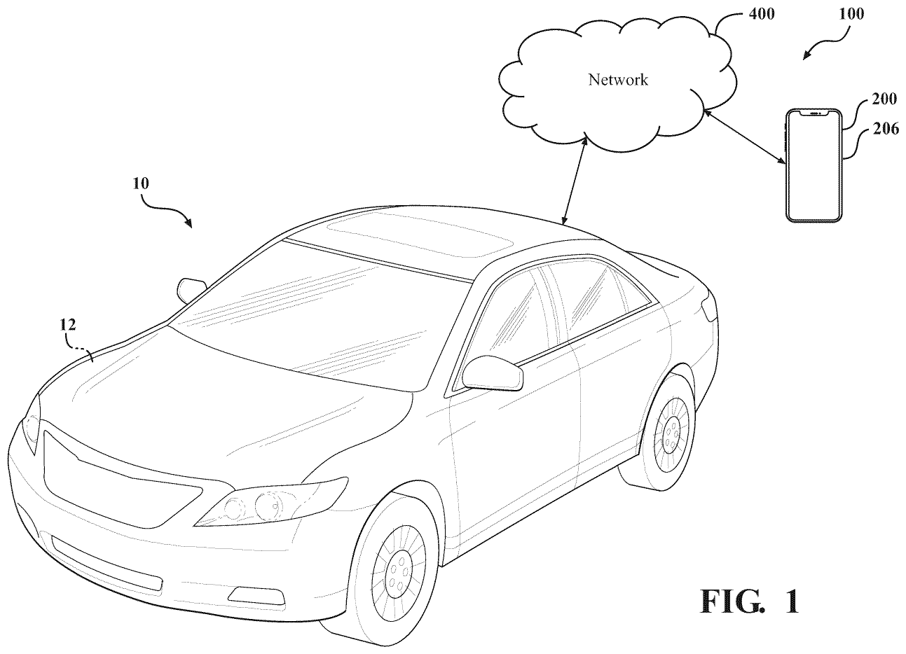

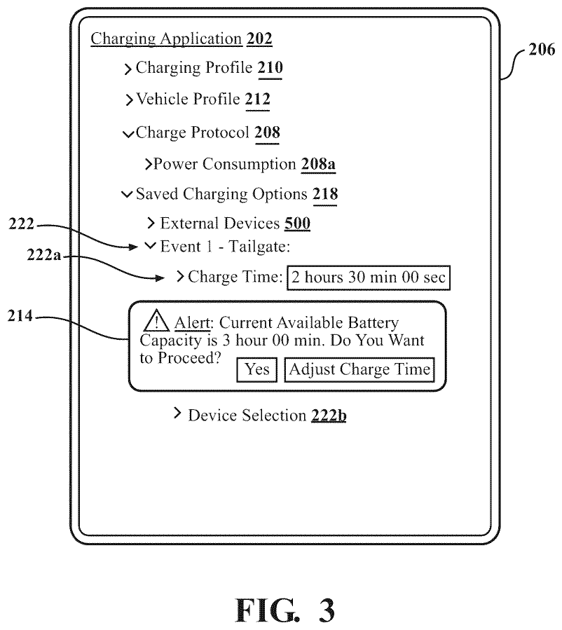

Referring to FIGS. 1-3, a charging control system 100 includes and connects a user device 200 with a vehicle controller 300 of a vehicle 10 via a network 400. The charging control system 100 is configured to receive a user input 102 from a user interacting with the user device 200. As described in more detail below, the user device 200 is communicatively coupled to the vehicle controller 300 and is configured with a charging application 202 to communicate with a battery 12 of the vehicle 10. For example, the charging application 202 may send a signal 104 to the vehicle controller 300 in response to the user input 102 to establish communication between the user device 200 and the vehicle controller 300, as described herein.

In some aspects of the disclosure, the vehicle 10 is an electric vehicle (EV) with autonomous or semi-autonomous capabilities. Additionally or alternatively, the vehicle 10 may be a hybrid vehicle incorporating both EV and internal combustion engine (ICE) components and capabilities.

The vehicle controller 300 may control and monitor the vehicle battery 12. For example, the vehicle controller 300 includes a memory 302 that stores a battery life 304, a charge log 306, and a battery capacity 308 of the vehicle battery 12. The battery life 304 corresponds to the current operable life of the battery 12 which, in some aspects, may be represented by a time duration of remaining operable life of the battery 12. The vehicle controller 300 is configured to take regular, repeated readings of the vehicle battery 12 to maintain the representative battery life 304. As will be described in detail below, the representative battery life 304 is used by the vehicle controller 304 when in communication with the charging application 202.

In determining the battery life 304, the vehicle controller 300 evaluates the battery power 310, which may be represented as a percentage value. The controller 300 may convert the percent value of the battery power 310 into a time value represented as the battery life 304, which assists in determining the battery capacity 308 with respect to charging other devices. The battery capacity 308 may be a reflection of both the battery power 310 and the battery life 304. For example, the battery capacity 308 may reflect potential charging capabilities based on the projected battery life 304 and current battery power 310.

Referring still to FIGS. 1-3, the memory 302 may also store a charging threshold 312, which defines a maximum capacity of potential charge options based on the battery capacity 308. For example, the vehicle controller 300 may communicate the charging threshold 312 with the charging application 202 of the user device 200, and the charging application 202 may compare the charging threshold 312 with the battery capacity 308 to ultimately present charging options to the user. In some aspects, the charging application 202 may present a first option to charge multiple devices for a short period of time and a second option to charge priority devices for a longer period of time, as compared to the first option. While the battery capacity 308 is dependent upon the battery life 304 and the battery power 310, it is also contemplated that the surrounding external environment may affect the battery capacity 308, as described below.

The vehicle controller 300 is communicatively coupled to the user device 200, which includes a display 204 and data processing hardware 206. The data processing hardware 206 is configured to execute the charging application 202 and also requests and executes a charge protocol 208 in response to the user input 102. As described further below, the charge protocol 208 is executed in accordance with the charging application 202, such that information and data categorized in the charging application 202 may be utilized by the data processing hardware 206 when executing the charge protocol 208. Stated differently, the charging application 202 may present a user-facing interface through which the signals 104 are sent, based on the user inputs 102, to initiate and execute the selected charge protocol 208.

The charging application 202 is configured to charge external devices 500 using the vehicle battery 12. As described further below, the charging application 202 is a user-facing interface that receives user inputs 102 to set and adjust the charge protocol 208 as it relates to the selected external devices 500. For example, the charge protocol 208 may be configured to charge a selected external device to a predetermined battery percentage, such that the charging application 202 may stop the charge protocol 208 once the external device 500 reaches the predetermined percentage. Additionally or alternatively, the charging application 202 may stop the charge protocol 208 in order to prioritize the battery capacity 308 of the vehicle battery 12. In some aspects, the charging application 202 may apply a prioritization to various external devices 500, such that some external devices 500 may take priority over other external devices. For example, accessory external devices 500a may have a lower priority as compared to utility external devices 500b.

The prioritization protocols that may be executed by the charging application 202 may be considered rationing options based on the conservation of the battery capacity 308 as a result of the execution of the prioritization. For example, the vehicle controller 300 may be configured to provide the data processing hardware 206 with battery rationing options at the minimum battery range 308a based on the current battery capacity 308. The charging application 202 may thus be configured to both charge various external devices using the vehicle battery 12 and may actively monitor, in combination with the vehicle controller 300, the energy consumption to prioritize the vehicle battery 12 for vehicle drivability.

Referring still to FIGS. 1-3, the charging application 202 includes a charging profile 210 and a vehicle profile 212. The charging profile 210 may include user preferences pertaining to devices 500 that may be utilized with the charging application 202. The charging profile 210 may also include information pertaining to preferred charging patterns and a home setting corresponding to a home of the user.

The charging application 202 also includes a vehicle profile 212 that includes vehicle identification information 212a and displays information received from the vehicle controller 300. It is generally contemplated that the vehicle profile 212 may be established by the user manually inputting the vehicle identification information 212a and/or through communication with the vehicle controller 300. In particular, the vehicle controller 300 transmits battery data to the user device 200 via the network 400. For example, the vehicle profile 212 may present the battery life 304, the battery power 310, and the battery capacity 308, each obtained from the vehicle controller 300, to the user to assist in selections made for the charge protocol 208. In some aspects, the battery life 304 presented may include a minimum battery life 304a, such that the charge protocol 208 may be set to alert the user via a notification 214 when the battery life 304 of the vehicle 10 is approaching the minimum battery life 304a. For example, data processing hardware 206 is configured to provide a notification 214 on the display 204 of the user device 200 indicating the battery life 304 is at the minimum battery life 304a and is configured to display nearby charging stations 502 for the vehicle 10.

The minimum battery life 304a is defined as the minimum battery volume at which the vehicle 10 may operate between locations. The user may adjust or set the minimum battery life 304a to adjust or accommodate for specific trip information. For example, the user may adjust the minimum battery life 304a to a greater value corresponding to a greater value of battery life 304 to accommodate a return trip of the vehicle 10 after using the charging application 202. Additionally or alternatively, the charging application 202 may be configured to communicate with the vehicle controller 300 to automatically adapt and adjust to the minimum battery life 304a based on a location of the vehicle 10 relative to a nearby charging station 502 or the home location of the user.

With further reference to FIGS. 1-3, the vehicle profile 212 also displays information related to the charge log 306, such that the vehicle profile 212 may present to the user a last full charge 306a of the vehicle 10. The data obtained from the charge log 306 may be utilized by the data processing hardware 206 to inform the user of the minimum battery life 304a in an alternate form. For example, the data processing hardware 206 may assess that the last full charge 306a occurred prior to trip departure and may evaluate data from the charge log 306 to determine whether any additional charging occurred between the last full charge 306a and the instant battery capacity 308.

Based on the data from the charge log 306, the data processing hardware 206 can determine the minimum battery life 304a before recommending that the user stop the charge protocol 208 to reserve sufficient battery life 304 for a return trip. The data processing hardware 206 may alternatively present the user with an option of a nearby charging station 502, which may prolong the charge protocol 208 based on the location of the vehicle 10. The notification 214 may also include information pertaining to directions to the nearest charging station 502, as described below. Thus, the user may select via the user input 102 whether to proceed with the charge protocol 208 until the minimum battery range 308a is met and then proceed to the nearest charging station 502, or to stop the charge protocol 208 at an earlier time period to reserve sufficient battery power 310 for the return trip.

Additionally or alternatively, the notification 214 may contain information pertaining to a minimum range 308a of the battery 12 based on the battery capacity 308. Thus, the charge protocol 208 may be adjusted based on the minimum battery life 304a and/or the minimum range 308a of the battery 12, such that the user may selectively reserve battery capacity 308 for a return trip after executing the charge protocol 208.

Referring still to FIGS. 1-3, the charging application 202 also includes saved charging options 218. The saved charging options 218 may include, but are not limited to, device profiles 220 and customized profiles 222. For example, the device profiles 220 may include the various external devices 500 compatible with the charging application 202, such as an accessory external device (i.e., a mobile device) 500a and a utility external device (i.e., a home generator) 500b. The user may selectively add and remove the external devices 500 from the charging application 202 and may select which of the external devices 500 to charge via the charge protocol 208. For example, the user may add or remove external devices 500 in the device profiles 220 and add or remove external devices in the customized profiles 222. Each device profile 220 may have a specific setting that can be added to the customized profiles 222 and may each have a customized charge time 222a, described below. Accordingly, the user may adjust charge settings for one of the external devices 500 from the customized profile 222 in the saved charging options 218.

The customized profiles 222 may be configured for various events and may include options pertaining to a charge time 222a and device selection 222b. The user may adjust the charge time 222a for a duration of the event or may select a predetermined time period. Optionally, the data processing hardware 206 may determine the charge time 222a that will result in a full charge of the selected device 500. In this example, the data processing hardware 206 may set the charge time 222a to complete upon full charge of the selected device 500 and may stop the charge protocol 208 once the selected device 500 obtains a full charge. The charge time 222a may be selected for each device 500 available from the device selection 222b, such that the data processing hardware 206 may execute a separate charge protocol for each device 500.

The device selection 222b may include the external devices 500 saved in the saved charging options 218 of the charging application 202. In some aspects, the charging application 202 may be configured to detect external devices 500 in the surrounding area and may present the detected external devices 500 to the user as part of the device selection 222b. The user may save detected external devices 500 to the device profiles 220 for future use or may opt to forget a detected external device 500 prior to completion of the charge protocol 208. It is also contemplated that the charge protocol 208 may be configured with a power consumption 208a that indicates the respective power consumption 208a of each external device 500. Thus, the user may track the various external devices 500 used with the charging application 202 to determine how much energy is being used by each.

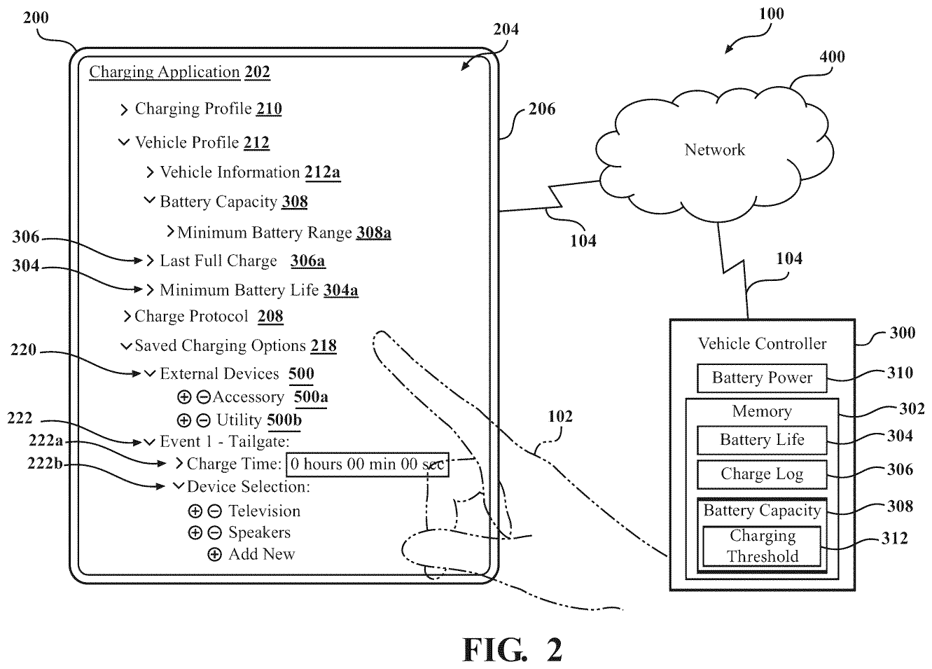

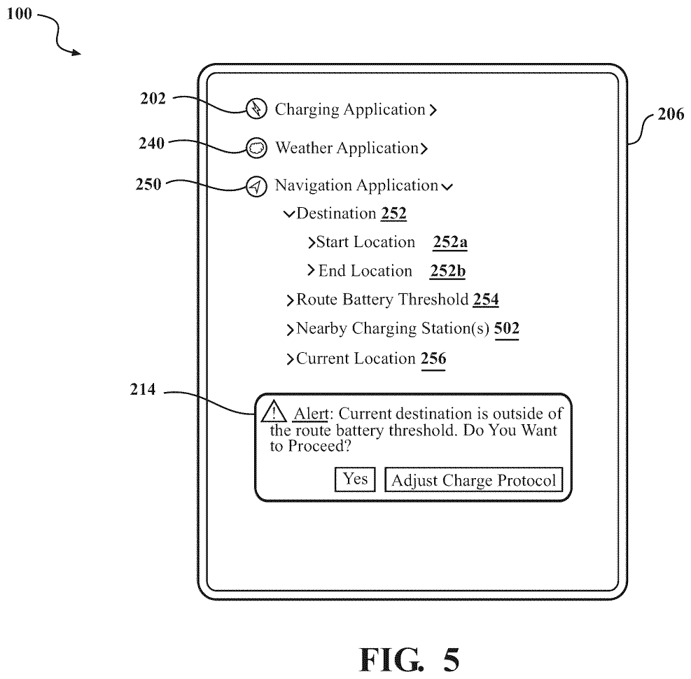

With reference now to FIGS. 2-5, the charging application 202 may present a notification 214 to the user in response to the selected charge time 222a when the selected charge time 222a approaches the battery capacity 308 of the vehicle battery 12. As generally mentioned above, the data processing hardware 206 is configured to determine the minimum battery range 308a based on the battery capacity 308 and the charge protocol 208, including the selected charge time 222a. The charging application 202 may present the user with the option to proceed with the selected charge time 222a or to adjust the selected charge time 222a to maximize the battery capacity 308.

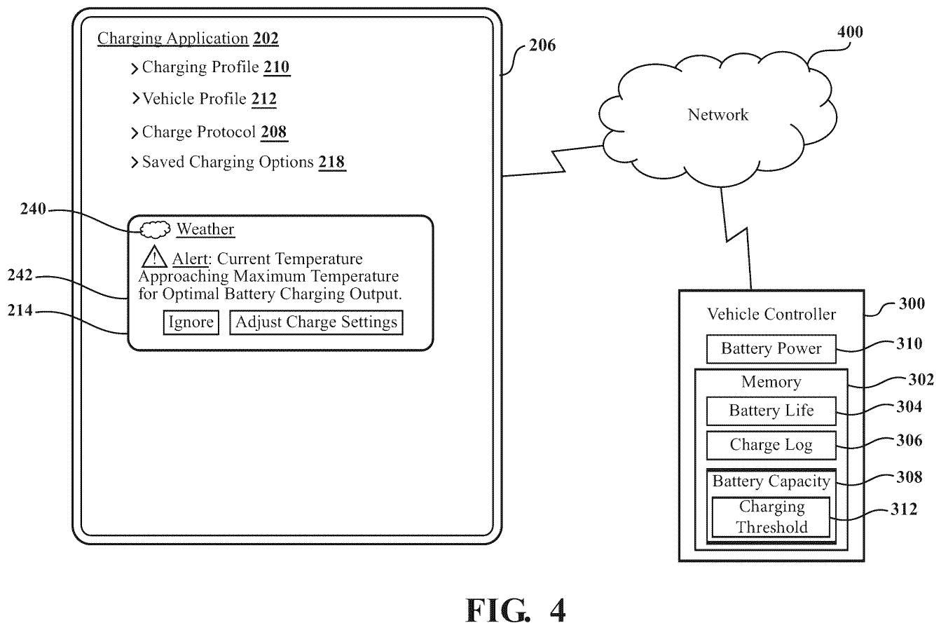

The user device 200 may also be configured with a weather application 240 communicatively coupled with the charging application 202 to provide weather data 242 that may affect or otherwise influence the charge protocol 208 of the charging application 202. The data processing hardware 206 may monitor an ambient temperature at a location of the vehicle 10 during the charge protocol 208. In some examples, weather may alter the output of the vehicle battery 12, such that extreme temperatures may alter the battery power 310 and, ultimately, the battery capacity 308. Thus, the charging application 202 may present the option to adjust the charge protocol 208 in response to weather patterns detected by the weather application 240. As illustrated in FIG. 4, the weather data 242 is illustrated as a notification 214 that presents the option to adjust the charge settings for the charge protocol 208 based upon a detected maximum temperature. Stated differently, the data processing hardware 206 is configured to issue notifications 214 in response to the weather data 242 received from the weather application 240. In other examples, the weather data 242 may relate to a decreased temperature, rain, snow, hail, or other weather patterns that may affect the battery power 310 of the vehicle 10. In some aspects, the data processing hardware 206 may adjust the charge time 222a of the charge protocol 208 in response to the weather data 242 received and the charging threshold 312 of the vehicle battery 12.

While the user may adjust the charge protocol 208, it is also contemplated that the user may optionally ignore the weather notification 214 and proceed with the preselected settings. The data processing hardware 206 may execute the charge protocol 208 and present a later notification 214 that the vehicle battery 12 is approaching the minimum battery life 304a or the minimum battery range 308a, as described above. It is generally contemplated that the user may selectively adjust the autonomous functions of the charging application 202 via the data processing hardware 206 to optionally adjust the settings preferences for automatic or manual adjustment of the charge protocol 208 in response to weather patterns detected by the weather application 240.

Referring still to FIGS. 2-5, the user device 200 may also include a navigation application 250. The navigation application 250 may also be communicatively coupled to the charging application 202 and provide information regarding a destination route 252, a route battery threshold 254, and nearby charging stations 502. The data processing hardware 206 may utilize the navigation application 250 in combination with the data received from the vehicle controller 300 to determine the route battery threshold 254 based on the current battery capacity 308 and the destination route 252. In response to the determined route battery threshold 254, the data processing hardware 206 may update the charging application 202 to reflect a new minimum battery range 308a.

In some examples, the route battery threshold 254 may be interchanged with the minimum battery range 308a. In other examples, the minimum battery range 308a may differ from the route battery threshold 254 in that the route battery threshold 254 is determined based on a specific route input into the navigation application 250 by the user. Thus, while the minimum battery range 308a may reflect a generalized distance range that the vehicle 10 may travel after the charge protocol 208, the route battery threshold 254 may reflect a threshold of the battery capacity 308 based on a specific route input. For example, the minimum battery range 308a may be a general mileage value indicating a general distance the vehicle 10 may travel based on the predicted battery capacity 308 after the charge protocol 208. The route battery threshold 254 may be presented as a value of the battery capacity 308 that would be utilized to complete the selected route based on a start location 252a and an end location 252b.

With further reference to FIGS. 2-5, the charging application 202 may update the charge protocol 208 based on any one or more of the minimum battery threshold 308a, the weather data 242, and the route battery threshold 254. For example, the charging application 202 may present a notification 214 to the user indicating that the current charge protocol 208 may deplete the battery life 304 and recommend adjusting, for example, the selected charge time 222a. Additionally or alternatively, the charging application 202 may recommend reducing the number of selected devices 500 to maximize the battery life 304.

In some aspects, the charging application 202 may present a notification 214 to the user of the various data points related to the charge protocol 208, including, but not limited to, the minimum battery threshold 308a and the route battery threshold 254. Based on a current location 256 of the vehicle 10, the charging application 202 may present the nearest charging station 502. The user may adjust or add a stop in the destination route 252 to include the charging station 502. The addition of the nearby charging station 502 to the destination route 252 extends the route battery threshold 254 and the minimum battery threshold 308a that may be reached during the charge protocol 208. Thus, the charge protocol 208 may be selectively adjusted, by the data processing hardware 206 or the user, in response to the detection of a nearby charging station 502 using the navigation application 250.

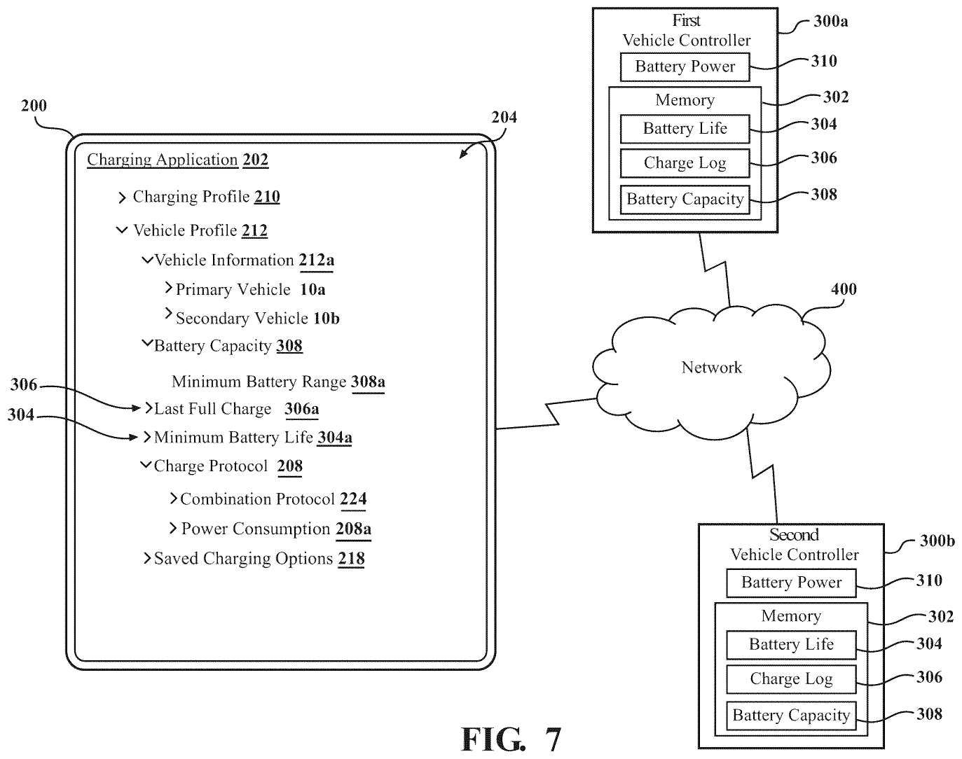

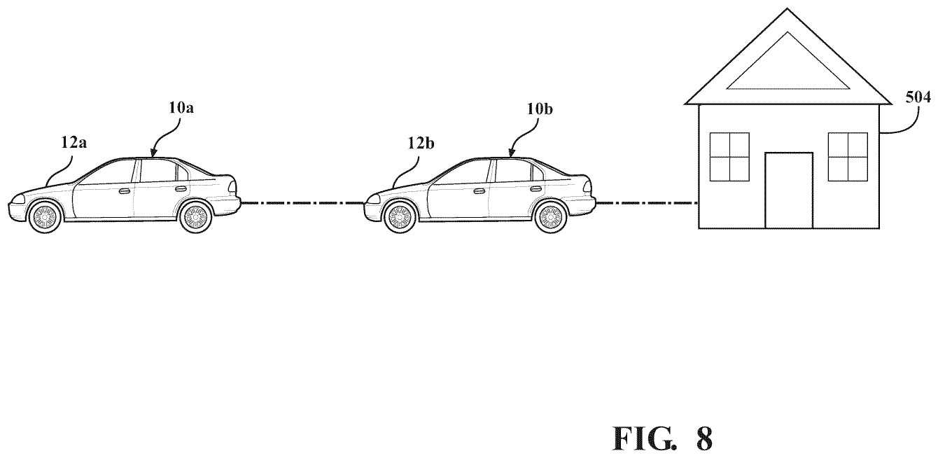

Referring now to FIGS. 2 and 6-8, the charging application 202 may be configured to detect multiple vehicles 10a, 10b. Each of the vehicles 10a, 10b is equipped with a vehicle battery 12a, 12b and a vehicle controller 300a, 300b. Each vehicle controller 300a, 300b is configured in the manner described herein, including each of the battery power 310, the battery life 304, the charge log 306, and the battery capacity 308. Similarly, the charging application 202 is configured to determine the minimum battery life 304a and the minimum battery range 308a using each vehicle 10a, 10b. For example, the charging application 202 may include a drop-down menu for each vehicle 10a, 10b within the vehicle profile 212 to illustrate the respective vehicle data.

In some examples, the charging application 202 may be configured to detect surrounding vehicles and notify the user of the availability to link or otherwise electrically connect the surrounding vehicles with the charging application 202. By connecting the vehicles 10a, 10b, the charging application 202 may be utilized to execute a larger charge volume. For example, the charging application 202 may utilize the battery data for multiple vehicles, such that the battery power 310a, 310b for each vehicle 10a, 10b may be utilized in the charge protocol 208.

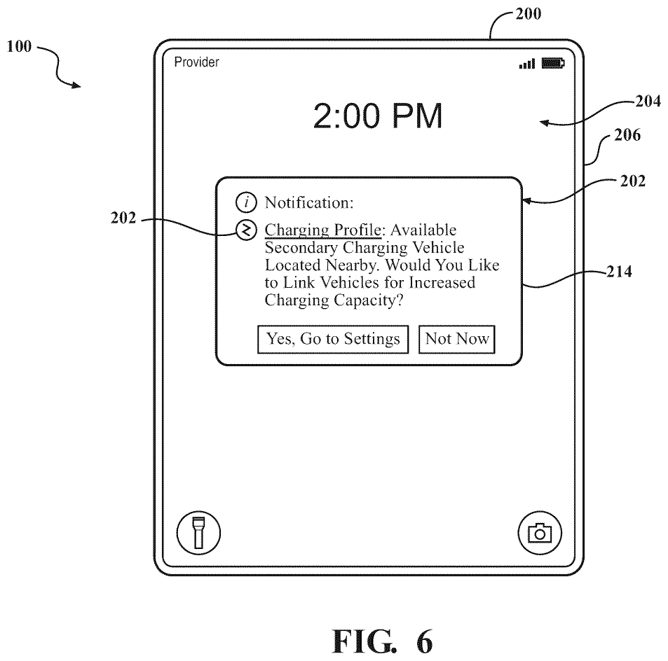

In some examples, the vehicles 10a, 10b may be electrically coupled to increase the overall battery power 310a, 310b available for the charge protocol 208. While described as two vehicles 10a, 10b being electrically coupled, it is contemplated that a plurality of vehicles 10, greater than two, may be electrically coupled to collectively increase the available battery power 310 for the charge protocol 208. The charging application 202 may present a notification, as illustrated in FIG. 6, alerting the user to the availability of a secondary charging vehicle 10b. The data processing hardware 206 may detect the secondary charging vehicle 10b using any practicable detection method including, but not limited to, Bluetooth® technology.

Additionally or alternatively, the user may manually input the secondary vehicle 10b into the vehicle profile 212 section of the charging application 202. For example, the user may have two vehicles 10a, 10b that may be used in combination with the charging application 202. Thus, the user may repeatedly use one or both of the vehicles 10a, 10b in combination with the charging application 202. In some aspects, the vehicles 10a, 10b may be used as part of a charge protocol 208 to provide power to a house 504 via a utility external device 500b. In this example, the user may have the utility external device 500b stored in the saved charging options 218 of the charging application 202 and may elect to utilize one or both of the vehicles 10a, 10b stored in the vehicle profiles 212.

Referring still to FIGS. 2 and 6-8, the combination of the vehicles 10a, 10b provides an increased duration of charging for the charge protocol 208, such that the power output from the charge protocol 208 may be greater as compared to a charge protocol 208 executed using a single vehicle 10a. The charging application 202 may be configured with a combination protocol 224 that may automatically combine the battery power 310a, 310b from each respective vehicle 10a, 10b. The combination protocol 224 may otherwise execute the same functions as the charge protocol 208, such that the combination protocol 224 may operate in conjunction with the various saved charging options in addition to the weather application 240 and the navigation application 250.

The combination protocol 224 may balance the use of the vehicle batteries 12a, 12b in that the combination protocol 224 may run a first vehicle battery 12a for a predetermined period of time and then switch to a second vehicle battery 12b for a second predetermined period of time. For example, the vehicle controller 300a, in combination with the data processing hardware 206, may selectively draw from the battery capacity 308 of the second battery 12b to supplement the battery capacity 308 of the first battery 12a. The charging application 202 is configured to simultaneously utilize the battery capacity 308 of the first battery 12a and the battery capacity 308 of the second battery 12b to execute the combination protocol 224. The combination protocol 224 may alternate back-and-forth between the vehicle batteries 12a, 12a to manage the usage of each respective battery 12a, 12b. Thus, each vehicle 10a, 10b may be monitored relative to a respective minimum battery life 308a. It is also contemplated that the user may manually adjust the combination protocol 224 to utilize the first vehicle battery 12a until the minimum battery life 308a is reached before switching to the second vehicle battery 12b. Further, the vehicle controllers 300a, 300b may be configured to redirect power from unused power sources of the respective vehicles 10a, 10b to maximize the respective battery capacities 308. It is also contemplated that the vehicle controllers 10a, 10b may cooperate with the data processing hardware 206 to selectively prioritize the external devices 500 based on the respective power consumptions 208a to maximize the battery capacities 308 of the respective vehicle batteries 12a, 12b.

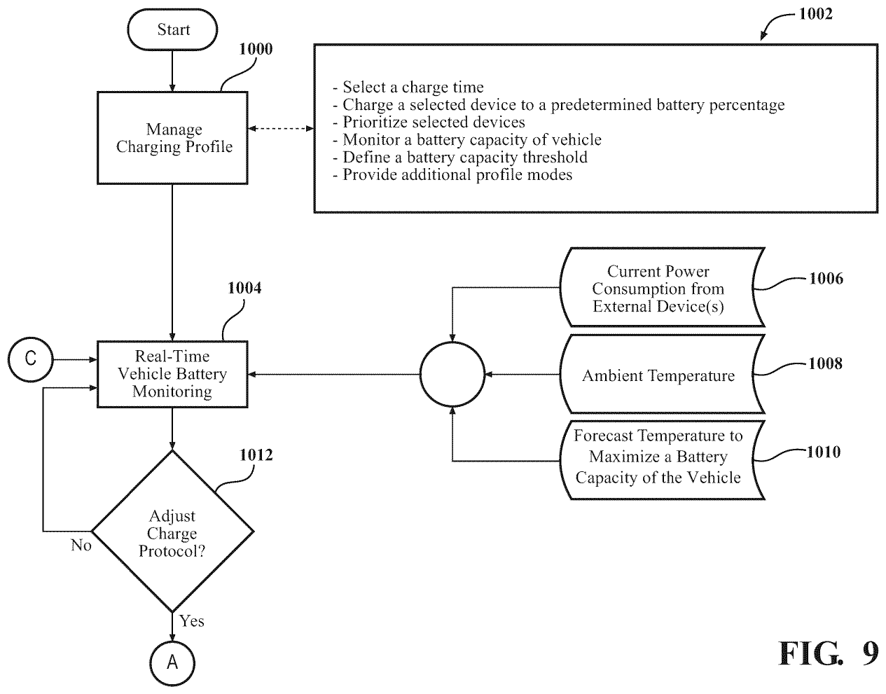

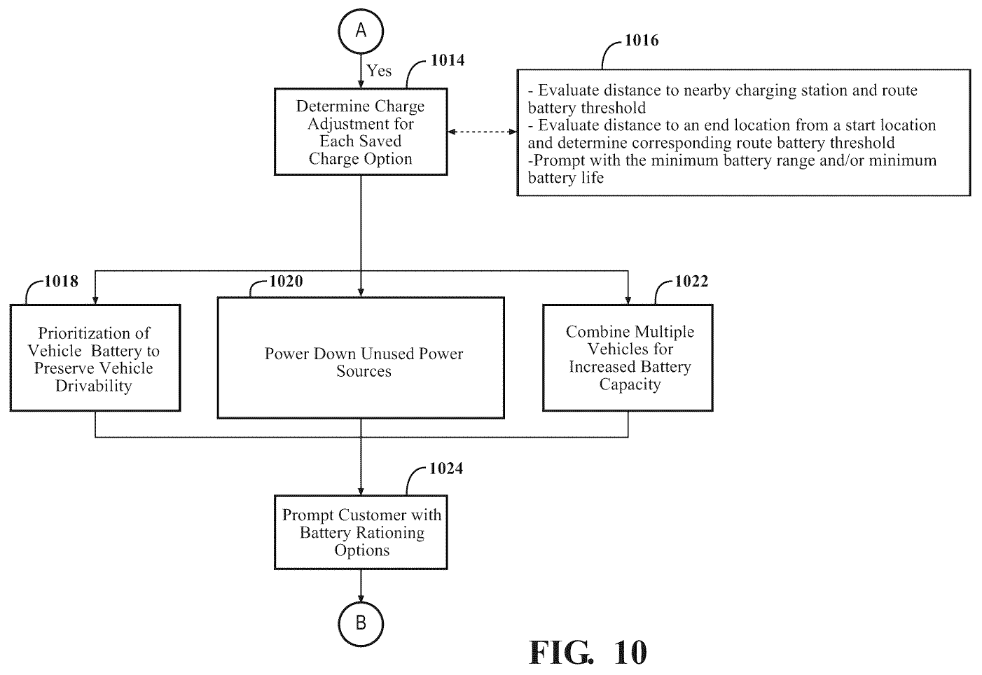

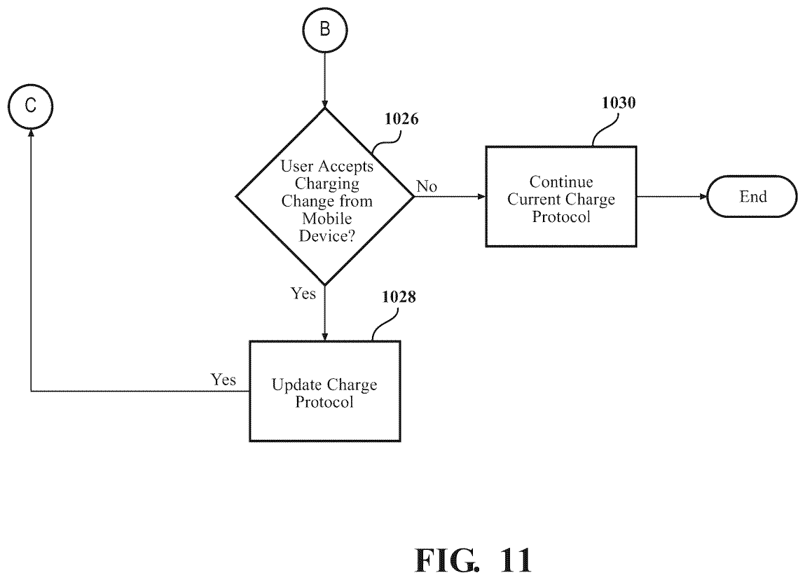

With specific reference to FIGS. 9-11, flow diagrams illustrating the operation of the charging control system 100 are depicted. Initially, at 1000, the user may manage a charging profile 210 and a vehicle profile 212 of a charging application 202. Examples of managing the charging application 202, at 1002, include, but are not limited to, selecting a charge time 222a, charging a selected device to a predetermined battery percentage, prioritization of selected devices, monitoring the battery capacity 308 of the vehicle 10, defining a battery capacity threshold 308a, and providing additional profile modes for the user. The charging application 202, at 1004, is configured to monitor the vehicle battery 12 in real-time. Real-time monitoring of the vehicle battery 12 includes, at 1006, 1008, 1010, but is not limited to, current power consumption from the external devices 500, the ambient temperature, and a forecasted temperature to maximize the battery capacity 308 of the vehicle 10. During the monitoring process, at 1012, the charging application 202 determines whether an adjustment to the charge protocol 208 should occur based on the charging parameters. If no adjustments are needed, the charging application 202 and, thus, the data processing hardware 206, continue to monitor the battery capacity 308 of the vehicle 10.

If the data processing hardware 206 determines an adjustment could be beneficial, then, at 1014, the data processing hardware 206 determines the adjustment in charging for each of the saved charge options 218 in operation. For example, at 1016, the data processing hardware 206 may evaluate the distance to a nearby charging station 502 and the route battery threshold 254 to determine how much battery capacity is required to travel to the nearby charging station 502. Additionally or alternatively, the data processing hardware 206 may evaluate a distance to an end location 252b from a start location 252a and determine the corresponding route battery threshold 254. The charging application 202 may also be configured to prompt the user of the minimum battery range 308a and/or the minimum battery life 304a, if the current battery capacity 308 and/or battery life 304 is approaching the respective minimum.

The charging application 202 may also present the option to combine multiple vehicles 10a, 10b to optimize the charge protocol 208 for the external devices 500 and may utilize customized prioritization by the user of power distribution. The data processing hardware 206 and the charging application 202 may then, in an indeterminate order at 1018, 1020, 1022, prioritize the vehicle battery 12 to preserve the drivability of the vehicle 10, power down unused power sources, and combine multiple vehicles 10a, 10b for increased battery capacity 308. The charging application 202 may then, at 1024, prompt the user with various battery rationing options. At 1026, the data processing hardware 206 determines whether the user accepted any of the changes to the charge protocol 208. If the user accepts the changes to the charge protocol 208, then, at 1028, the data processing hardware may adjust the charge protocol 208 and go back to real-time monitoring of the vehicle battery 12, at 1004. If the user rejects the changes to the charge protocol 208, then, at 1030, the charging application 202 continues executing the charge protocol 208 until a termination period is reached.

Referring again to FIGS. 1-11, the charging control system 100 optimizes a charging capability between a vehicle 10 and various external devices 500 via a user device 200. The charging control system 100 assists the user in customizing a charging profile 210 and a vehicle profile(s) 212 to seamlessly execute a charge protocol 208 from the user device 200 via a charging application 202. For example, the charging application 202 may charge a selected device to a predetermined device battery percentage based on a user input 102. In some examples, the charging application 202 may charge the selected device for a predetermined period of time based on the user input 102. Thus, the charging application 202 may be utilized to customize charging options for various external devices 500, while monitoring the status of the vehicle battery 12 through communication with the vehicle controller 300 over the network 400.

Further, communication between the charging application and both a weather application 240 and a navigation application 250 assists the user in tracking and monitoring the battery capacity 308 of the vehicle battery 12 as it relates to planned travel and charging of the external devices 500. Additionally or alternatively, the integration of each of the charging application 202, the weather application 240, and the navigation application 250 with the data processing hardware 206 allows the data processing hardware 206 to monitor a status of the vehicle battery 12 independent of user monitoring. Thus, the data processing hardware 206 may instruct the charging application 202 to prioritize the vehicle battery 12 based on the location of the user and/or the forecasted weather.

In some aspects, the charging application 202 is configured to automatically detect and prompt the connection of multiple vehicles 10a, 10b to maximize the charging output. The connection of multiple vehicle batteries 12a, 12b may prolong the charge protocol 208. Utilizing a combination protocol 224 of the charging application 202 may provide a greater power output, such that the combination protocol 224 may be utilized with external devices 500 that utilize a greater amount of power (i.e., a home generator). In addition, the charging application 202 may prompt the user of various prioritization options, such as executing the charge protocol for a utility external device as compared to an accessory external device. For example, the charging application 202 may present the option to charge the utility external device for a longer period of time as compared to the accessory external device.

The prioritization may be further determined by the data processing hardware 206 based on the data received from each of the weather application 240 and the navigation application 250. Thus, the charging control system 100 utilizes information from various resources to assist the user in selecting various charge protocols 208 by gathering data from the vehicle controller 300, the weather application 240, and the navigation application 250, in addition to information manually entered by the user into the charging application 202 to consolidate the available charging options.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A charging control system for a vehicle, the charging control system comprising:
a user device including a display and data processing hardware in communication with the display and executing a charging application that stores a charging profile, a vehicle profile, and saved charging options; and
a vehicle controller communicatively coupled to the user device via a network, the vehicle controller storing at least one of battery power, battery life, and battery capacity of a vehicle battery and being configured to update the vehicle profile of the charging application and provide charge options on the display including at least one of a charge time, charging locations, and battery capacity when the charging application is executed on the data processing hardware.

2. The charging control system of claim 1, wherein the data processing hardware is configured execute a charge protocol for an external device in response to a user input selecting one of the saved charging options.

3. The charging control system of claim 2, wherein the user input includes a charge time, the vehicle controller being configured to provide the battery power of the vehicle battery in response to the user input and to provide the battery capacity in response to the charge time.

4. The charging control system of claim 2, wherein the data processing hardware is configured to provide a notification on the display indicating the battery life is at a minimum battery life and is configured to display nearby charging stations for the vehicle.

5. The charging control system of claim 1, wherein the charging profile stores a charge time, the vehicle controller being configured to communicate with the data processing hardware the battery capacity via the network based on the charge time.

6. The charging control system of claim 5, wherein the battery capacity includes a minimum battery range, the vehicle controller being configured to stop the charge time at the minimum battery range.

7. The charging control system of claim 1, wherein the data processing hardware stores a weather application in communication with the charging application, the data processing hardware being configured to issue notifications to a user in response to data received from the weather application.

8. The charging control system of claim 7, wherein the data processing hardware is configured to charge a utility external device in response to a weather notification from the weather application.

9. A charging control system, comprising:
a user device including a display and data processing hardware in communication with the display and storing a weather application and a charging application that when executed on the data processing hardware cause the data processing hardware to perform operations in response to a user input corresponding to a charge protocol and weather data received from the weather application; and
a vehicle controller storing a battery capacity of a vehicle battery and being configured to receive a signal from the data processing hardware and provide the battery capacity to the data processing hardware, the data processing hardware being configured to determine a charging threshold of a vehicle battery based on the battery capacity and adjust a charge time of the charge protocol in response to the weather data received and the charging threshold of the vehicle battery.

10. The charging control system of claim 9, wherein the battery capacity includes a first battery capacity of a first vehicle battery and a second battery capacity of a second vehicle battery, the first battery capacity selectively coupled to the second battery capacity.

11. The charging control system of claim 9, wherein the user device stores a navigation application, the data processing hardware being configured to calculate a route battery threshold based on the battery capacity, the charge protocol, a start location, and an end location.

12. The charging control system of claim 11, wherein the data processing hardware is configured to determine whether the end location exceeds the route battery threshold.

13. The charging control system of claim 9, wherein the vehicle controller is configured to prompt the data processing hardware with battery rationing options at a minimum battery range based on the battery capacity.

14. A vehicle including the charging control system of claim 9.

15. A charging control system for a vehicle, the charging control system comprising:
a user device including a display and data processing hardware in communication with the display and storing a weather application and a charging application that when executed on the data processing hardware cause the data processing hardware to perform operations in response to receiving a user input corresponding to a charge protocol and receiving weather data from the weather application; and
a vehicle controller storing a first battery capacity of a first vehicle battery and a second battery capacity of a second vehicle battery and being configured to receive a signal from the data processing hardware and provide the first battery capacity and the second battery capacity to the data processing hardware, the data processing hardware being configured to adjust a charge time of the charge protocol based on one of the first battery capacity and the second battery capacity.

16. The charging control system of claim 15, wherein the vehicle controller is configured to selectively draw from the second battery capacity to supplement the first battery capacity.

17. The charging control system of claim 16, wherein the user input includes selecting a combination protocol stored by the charging application, the charging application being configured to simultaneously utilize the first battery capacity and the second battery capacity to execute the combination protocol.

18. The charging control system of claim 15, wherein the data processing hardware is configured to prompt a user with an option to adjust the charge protocol based on the weather data received from the weather application.

19. The charging control system of claim 15, wherein the charging application is configured to display a power consumption of at least one of the first battery capacity and the second battery capacity by at least one external device.

20. The charging control system of claim 15, wherein the vehicle controller is configured to redirect power from unused power sources to maximize at least one of the first battery capacity and the second battery capacity.
